(19) United States
(12) Patent Application Publication
(10) Pub. No.: US 2005/0286068 A1
(43) Pub. Date: Dec. 29, 2005

(54) Monitoring the status and performance of printing devices

(76) Inventors: Bruce L. Johnson, Eagle, ID (US); William M. French, Boise, ID (US); Susan M. Janz, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/877,635

(22) Filed: Jun. 24, 2004

(51) Int. Cl. G06F 15/00

(52) U.S. Cl. 358/1.14; 358/1.1

(57) ABSTRACT

Systems, apparatus and methods are described whereby a common power distribution line to which a number of non-networked printers at a given site are connected. The printers are enabled to transfer performance data such as the number of pages printed by each printer to a central data collection station. The central data collection station aggregates the data from each printer may send the aggregated data onto a system print owner/manager. Each printer in the system is provided with a modified power supply or “brick” which normally functions to transform the supply current from the power distribution line to a lower voltage (i.e., 24 v AC) and supply the transformed voltage to the printer for operation thereof. A power-line networking function or capability is added to the “brick” which allows it to communicate with a data collection appliance over the common power distribution line. The “brick” is also modified to contain a feature which permits counting of each page printed on a respective printer.

### BACKGROUND

This invention relates to the printing of documents including text and visual images in accordance with digitally recorded data. The most common printers capable of reproducing such documents from recorded data are laser and inkjet printers. More particularly the invention relates to monitoring the performance of a plurality of printers in a non-networked environment. It is often desirable for an organization to be able to determine the extent of usage of a printer as for billing and/or cost purposes. With most network-connected devices this is not a problem since such devices may be accessed via the network and the desired data obtained using network protocols such as SNMP (Simple Network Management Protocol) or similar protocol systems currently in use. In a large enterprise environment there may also be a plurality of printers, each connected directly to a specific computer. Such printers are not directly accessible via the network, and therefore standard methods of monitoring over the network will not work. Such printers are difficult to track and maintain in a large enterprise. In the ideal managed printer environment, the billing rates are based on the actual usage of a printer as determined by page count. As an alternative to the page count method as a basis for billing, a flat rate contract may be utilized which obviates the need to count the pages printed. If this is unacceptable, pages must be counted manually by sending service personnel to each device to procure the page counts via the printer test page. This procedure, like reading the gas meters in each individual home or business, involves a considerable amount of manpower and is very costly. Furthermore the status of each printer as to the amount of consumable (i.e., ink or toner powder) available as well as the need for maintenance services may not be known until the user experiences a breakdown or cessation of the printing operation. In addition, non-networked printers are highly desirable in that, lacking any built-n network, they may be small in size, inexpensive and easy to use, especially occasionally. The present invention provides a means for monitoring non-networked printers without the need for installing a dedicated networking capability so as to economically obtain status and performance data. The invention also permits management of a large number of printers that are in use at customers sites wherever located.

### SUMMARY

According to the present invention systems, apparatus and methods are provided whereby the power line (hereinafter referred to as the power distribution line) which supplies electrical power to the various printers at a given site is enabled to act as a network to transfer performance data from each printer to a central data collection station or host device which collects and aggregates the data from each printer and sends the aggregated data onto a data collection device or appliance for eventual delivery to the system print owner/manager. More particularly, as is well known and customary, each printer includes a modular power supply or “brick” having a power cord on one side connecting the “brick” to the electrical power distribution line (i.e., 120 v AC) at the site. The other side of the “brick” has a power cable connecting the “brick” to the printer. The “brick” normally functions to transform the supply current down to a lower voltage (i.e., 24 v AC) and supply the transformed voltage to the printer for operation thereof. The invention further proposes that a power-line networking function or capability be added to the “brick” to allow the “brick” to communicate with the data collection appliance at the customer/user site. The “brick” also contains a feature to count the pages printed on the device.

### BRIEF DESCRIPTION OF DRAWINGS

The disclosed systems and methods can be better understood with reference to the following drawings. The components in the drawings are not necessarily to scale.

FIG. 1 is a schematic illustration of an embodiment of a printing system environment or site with a plurality of printers “networked” via a power distribution line.

FIG. 2 is a schematic diagram of a printer power transformer assembly (“brick”) for use in the practice of the invention.

### DETAILED DESCRIPTION

Disclosed herein are embodiments of systems, apparatus and methods for implementing the present invention so as to provide for the monitoring of a number of non-networked printers which are connected to a common power supply. Although particular embodiments are disclosed, these embodiments are provided for purposes of example only so as to facilitate description of the disclosed systems and methods. The description that follows herein is presented largely in terms of processes and symbolic representations of operations performed by conventional computers and peripheral devices such as printers and the like.

The computers and printers to which the invention is applicable may advantageously contain program logic or other equivalents representing data and instructions, which cause the computers and printers to operate in a specific and predefined manner. The program logic may be advantageously implemented as one or more modules which may be configured to reside in or on the memory of the computers and/or printers for execution on one or more of the processors included in the computers or printers. These modules may include, but are not limited to, software, firmware or hardware components that cause the performance of certain tasks. It should be understood that manipulations within processors are often described in terms of machine actions caused to be performed by the processor such as adding, processing, comparing, retrieving, printing, playing, moving, searching, transmitting, and the like. It should also be understood that the programs, modules, processes, methods and the like described here are exemplary implementations and are not related or limited to any particular computer, apparatus or computer language. Various types of general purpose computing machines, printers or devices may be used according to the teachings of the invention described herein.

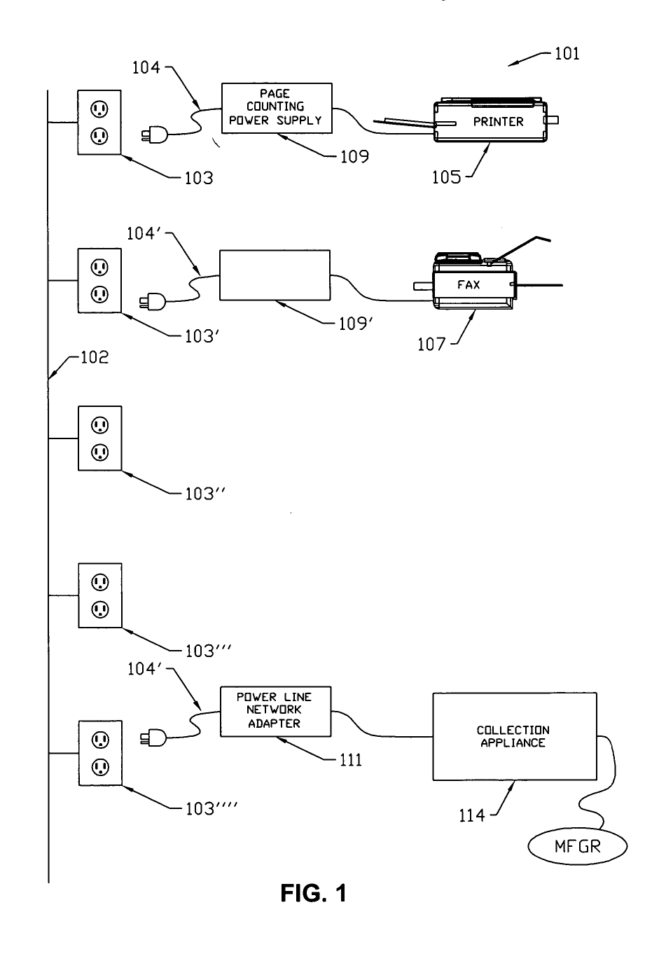

FIG. 1 illustrates a typical printing environment or system 101 which includes one or printers 105 for example which do nothing more than print out documents or images in response to commands from one or more computers (not shown). The system 101 may also include specialized devices such as facsimile machines 107 which include, among other functions, printers which accomplish the printing out of documents or data and images in response to electrical signals representing such data received over or via conventional telephone or data communication lines (not shown). As is well known such printing devices are provided with electrical power for operation by connections to a common power distribution line 102 having receptacles 103′, 103″, 103′″, 103″″ for receiving conventional electrical connectors or plugs 104, 104′, 104″. The power distribution line 102 may comprise a circuit supplying the conventional 60 cycle/120 volt electrical power (“house” current). However, most printing devices of the inkjet or LaserJet variety for use with the present invention do not need or operate on the voltage of the magnitude supplied by the conventional house current. The printers for which the present invention is intended for use may utilize and operate on voltages of 24 volts, for example, supplied by a modular power supply consisting of what is commonly called a “brick”. The modular power supply provided by the printer manufacturer with the printer usually provides power transformation only and is connected to the power distribution line 102 via a power cord and plug 104 on one side and a power cable 107, 107′ to the printer 104 on the other side. The present invention provides that a networking function or capability be added to the power supply or “brick” 109 so as to allow the modified “brick” to communicate with a central data collection appliance 114 at the customer/user site. As will be more described hereinafter, the collection appliance 114 aggregates data from various printers in the system and sends the data either to the customer's management station or to the manufacturer who may be providing maintenance service or leasing printers to the customer/user. The “brick” 109 may also be provided with the capability of measuring the quantity of work performed by the printer as with a counter which counts the number of pages printed on a per printer basis.

The data collection appliance 114 may be a standard or conventional personal computer containing a running software program. The computer may be located in the customer's data center, and connected to the customer's power distribution line network as shown and described. This computer may also, for example, be periodically connected to the printer manufacturer via the Internet. The data collection appliance 114 may also receive a list of the printers or other devices to be interrogated for page count and status information. The appliance 114 uses this list to contact the printers remotely over the power distribution line network and obtains the requested information. Usually, this is done using the simple network management protocol or SNMP. SNMP provides both read and write access to a collection of data stored inside the printer defined by a MIB (Management Information Base). When all the information has been gathered, the data collection appliance 114 may then connect to the manufacturer and upload the requested data indicating the status of each printer. While present data collection appliances may only collect data from network-connected devices, by adding a power line network adapter 111 according to the invention, the data collection appliance 114 is enabled to collect data from non-networked printers as well.

According to the invention, power line networking is a technique permitting the encoding of data over existing power distribution lines. The power line adapter 111 filters back data to the collection appliance 114 signals received from power distribution line networked printers for reading and utilization. As described previously, power line networking is used in situations where it is undesirable, inconvenient or not possible to provide separate data collection lines as in a traditional data network. For example, in the well known X10 system, (www.x10.com), which is a communications “language” that allows compatible products to talk to each other using the existing electrical wiring, small pieces of information in the form of electrical signals representing printer and/or performance data may be superimposed on the power signal during the zero crossings of the AC power signal. For more information regarding X10 systems see www.X10.com. In more modern power line networks, high speed TCP/IP signals may be utilized to run over power distribution lines with data rates up to a megabit or more. The hardware for doing this is commonly available and information on power line networking may be obtained from the following URL: http://www.homeplug.com/powerline/

As noted above, printing devices are provided with the appropriate power for operation of the printer via what is essentially a transformer device (“brick”) 109 inserted between the printer 105 and the available common power distribution system 102. This transformer may also be provided with a page counting capability. When a page is advanced in the printer, a surge in the supply line current occurs which may be detected and used to predict the number of pages to be printed. Counting power surges is the preferred method to determine the page count of a printer according to the invention. Most printers employ a stepper motor to accomplish advancement of each sheet of paper in the feed mechanism of the printer. The coils of the stepper motor are pulsed one at a time in order to rotate the motor shaft to advance the paper. In advancing the paper, such pulses occur at a fixed frequency and are detectable by corresponding current pulses in the supply current for the printer which pulses are detected in the printer's page counting circuit. When the pulse count reflects the total motion of the feed motor to accomplish advancement of the paper corresponding to its length (i.e., 11 inches), a page count is incremented and the pulse counter is set to zero.

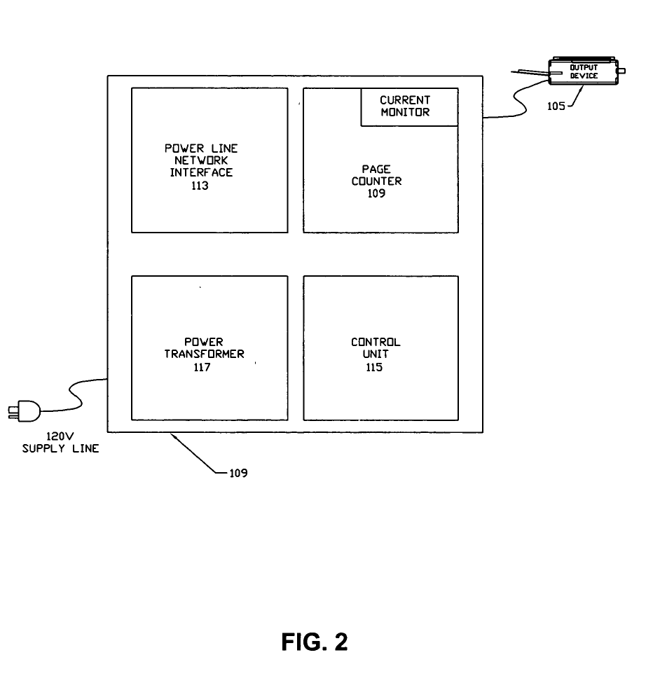

With reference to FIG. 2, a power assembly or “brick” 109 for insertion between a printer 105 and the power supply line 102 is shown schematically, modified according to the invention to enable the accomplishment of several functions. Thus, the power assembly 109 comprises a power transformer 117 to convert the power distribution line voltage to that required by the printer. Secondly, a page counter 109 is included to monitor the current being supplied to the printer so as to provide a pulse count indicative of the printing of a page as described previously. Thirdly, the power assembly 109 includes a power line network interface or adapter 113 so that a networking function or capability is provided permitting the encoding of data over existing power distribution lines. Finally, a control unit 115 is provided to control and coordinate the operation of the various elements and aspects of the power assembly 109. Thus, the control unit 115 collects and stores the page count data for its associated printer and forwards this data over the power distribution line using the power line interface 113 when requested. The control unit 115 also configures the network parameters for the power line network interface 113 with an IP address or community name. The control unit 115 is constituted by and implemented in an embedded microcontroller containing one or more RAM (Random Access Memory) units, a processing unit, and one or RAM Read Only Memory) units programmed with software, and an I/O (Input/Output) unit so as permit interfacing with other system components. The main components or aspects of the software will include the SNMP agent, the TCP/IP stack (including web and DHCP services and capabilities), the network configuration module for setup and DHCP functions, and data collection module.

1. A system for monitoring the status and performance of one or more devices comprising a common power distribution line for said devices, a power transformer assembly for each of said devices connected between a respective device and said common power distribution supply line, each power transformer assembly including means for collecting performance data for said respective device connected thereto.

2. The system according to claim 1 wherein said devices include a printing function.

3. The system according to claim 2 wherein said printers are inkjet printers.

4. The system according to claim 1 wherein said power transformer assembly includes means for measuring the quantity of work performed by said discrete device.

5. The system according to claim 4 wherein said discrete device is a printer.

6. The system according to claim 5 wherein said means for measuring comprises a page counter.

7. The system according to claim 1 wherein said power transformer assembly includes means for controlling said means for collecting said performance data.

8. The system according to claim 1 wherein said power transformer assembly includes network interface means so as to permit the transmission of data over said power distribution line.

9. The system according to claim 4 wherein said power transformer assembly includes a network interface means, a power transformer; a page counter, and a control unit for controlling and coordinating the functions of said network interface means, said power transformer, and said page counter.

10. The system according to claim 1 wherein a data collection appliance is connected to said power distribution line for collecting and storing information relating to performance aspects of said devices.

11. The system according to claim 10 where said one of said performance aspects is the number of pages printed by each of said devices.

12. The system according to claim 10 wherein said data collection appliance is connected to said power distribution line by means of a power line network adapter.

13. A power transformer assembly for use in a system wherein a printer is connected to a power distribution line, said assembly comprising a power line network interface, a power transformer, a page counter, and a control unit for controlling and coordinating the functions of said network interface, said power transformer, and said page counter.

14. The power transformer assembly according to claim 10 being connected between said printer and said power distribution line.

15. A modular assembly for use in a system for monitoring the status and performance of one or more printing devices and transmitting data indicative of the status and performance of one of said printing devices to a central station over a power distribution line, said modular assembly comprising a power transformer component, a performance measuring component, a power line network interface component, and a control unit for coordinating and controlling the functions of said components.

16. The modular assembly according to claim 12 wherein said performance measuring component is a page counter.

17. The method of securing performance data from one or more non-networked devices which are connected to-a common power distribution line, comprising measuring the performance of said devices, and supplying the data representing device performance to a data collection appliance by transmitting said data via said common power distribution line.

18. The method according to claim 17 wherein said devices are printers and said performance data represents the number of pages printed by a discrete printer.

19. The method according to claim 17 wherein said data representing device performance is converted to electrical signals suitable for transmission over said common power distribution line.

20. The method according to claim 17 wherein said performance data is transmitted from said collection appliance to a central management station.

21. The method according to claim 16 wherein said page counter monitors the secondary supply current of the device to determine the number of pages printed.

22. The method according to claim 16 wherein said page counter monitors the secondary supply voltage of the device to determine the number of pages printed.
